(19) United States
(12) Patent Application Publication
(10) Pub. No.: US 2018/0343069 A1
(43) Pub. Date: Nov. 29, 2018

(54) METHODS USING A HAND AND HEAD PHANTOM FOR MEASURING RADIATION POWER IN A WIRELESS COMMUNICATION SYSTEM

(71) Applicant: Carolyn Taylor, (US)

(72) Inventor: Carolyn Taylor, (US)

(21) Appl. No.: 15/552,681

(22) PCT Filed: Feb. 24, 2016
(86) PCT No.: PCT/EP2016/019246

§ 371 Date: Aug. 22, 2017

Related U.S. Application Data
(60) Provisional application No. 62/120,072, filed on Feb. 24, 2015.

(51) Int. Cl. H04B 17/10; H04W 76/20

(52) U.S. Cl. CPC H04B 17/10; H04W 76/20

(57) ABSTRACT

On a user equipment that is proximate to a phantom, a method for determining the total radiated power of the user equipment includes, in response to a preset criterion, obtaining a characteristic of the phantom, obtaining a characteristic of an antenna of the user equipment, and obtaining a radio characteristic of the user equipment. The method may also include transmitting the phantom characteristic, the antenna characteristic, and the radio characteristic to a test equipment.

### FIELD

The present disclosure is related generally to measuring radiated power of wireless devices and, more particularly, to measuring the radiated power of a wireless device that is proximate to a phantom.

### BACKGROUND

The 3rd Generation Partnership Project (3GPP) is the organization for the standardization of the Universal Mobile Telecommunication System (UMTS) and Long Term Evolution (LTE). Wireless communication is continuously evolving. There are many types of advanced technology equipment being introduced that can provide services that were not possible previously. This advanced technology equipment might include, for example, an Enhanced Node B (eNB) or other systems and devices that are more highly evolved than the equivalent equipment in a traditional wireless telecommunications system. Such advanced or next generation equipment may be referred to herein as High Speed Packet Access (HSPA) equipment, LTE, whose networks are also known as Evolved Universal Terrestrial Access Network (E-UTRAN), is a technology that can reach high data rates both in the downlink as well as in the uplink. LTE allows for a system bandwidth of 20 MHz, or up to 100 Hz with certain features. Devices with wireless communications capabilities, such as mobile telephones, handheld devices, devices embedded in laptop computers, Machine-2-Machine devices (M2M), and similar devices, will be referred to herein as User Equipment (UE) or wireless devices.

A heterogeneous network (HetNet) is a network that includes infrastructure points with various wireless access technologies, each of them having different capabilities, constraints, and operating functionalities. A typical HetNet includes a mix of macrocells, remote radio heads, and low-power nodes such as picocells, femtocells, and relays.

Leveraging network topology, increasing the proximity between the access network and the end-users, has the potential to provide the next significant performance leap in wireless networks, improving spatial spectrum reuse and enhancing indoor coverage.

Different UEs might use different types of radio access technology (RAT) to access a wireless communications network. Some UEs, referred to as multi-mode UEs, are capable of communicating using more than one RAT. For example, multi-mode UEs may include UEs that can obtain service from at least one mode of UMTS, and one or more different technologies such as GSM (Global System for Mobile Communications) or other radio systems. As defined herein, multi-mode UEs may be of any various type of multi-mode UE as defined or provided in 3GPP, Technical Specification Group (TSG) Terminals, Multi-Mode UE Issues, Categories, Principles and Procedures (3G TR 21.910). Some examples of RATs or network technologies that might use different types of RATs include UTRAN (UTMS Terrestrial Radio Access Network), GSM, GSM Enhanced Data rates for Global Evolution (EDGE) Radio Access Network (GERAN), Wireless Fidelity (WiFi), General Packet Radio Service (GPRS), High-Speed Downlink Packet Access (HSDPA), HSPA, and LTE. Other RATs or other network technologies based on these RATs may be familiar to one of skill in the art.

Government agencies frequently regulate how much power wireless devices are permitted to radiate. This is because the radiated power of a wireless device can potentially interfere with other devices. Therefore, wireless device manufacturers typically measure radiated power as part of the normal test process for such devices.

There are at least two different ways to measure the radiated power of a wireless device. One way is to measure the Equivalent Isotropically Radiated Power (EIRP) in an arbitrary direction. Another is to measure the total radiated power (TRP) emitted to the entire space. Measuring EIRP is considered to be complicated and time consuming. Consequently, TRP is is usually measured instead of EIRP.

The Specific Absorption Rate (SAR) is also something that wireless device manufacturers and carriers may need to take into consideration. The SAR is used to measure impact on the human body from the exposure of the radio-frequency electromagnetic field generated by the wireless device. SAR is a measure of the maximum energy absorbed by a unit of mass of exposed tissue of a person using a wireless device over a given time. In other words, it is the power absorbed per unit mass. There are many wireless devices types that can be used in many positions relative to the human body, e.g. speech and data communications with different SAR performance requirements.

The over-the-air (OTA) performance of a wireless device is normally dependent on the antenna performance. The human body may affect the antenna performance since wireless device are often used in close proximity to a human body. To simulate a human body for the purpose of evaluating antenna performance of a wireless device, an anthropomorphic human body (or parts thereof) is often used. The term “phantom” as used herein refers to one or more parts of an anthropomorphic human body. Wireless devices are typically tested next to or attached to a human head model, which is called Specific Anthropomorphic Mannequin (SAM) head phantom. The SAM is designed to take into consideration the influences of blocking and reflection and/or absorption of radio waves by a human head. The SAM phantom has been standardized by the International Electrotechnical Commission (IEC).

When a person holds a wireless device next to his or her head, this position is often referred to as a “speech communication mode.” When a person holds a wireless device in his or her hand (e.g., for web browsing), this position is often referred to as a “data communication mode.” In the data communication mode, the antenna performance of the wireless device may be affected by the human hand. The data communication mode can be simulated by a hand phantom. The shapes and grip of the hand phantom should be based on premise of a communication state. When a user employs a wireless device is in the data communication mode, it tends to be farther away from the user's body than the user employs the device in a speech communication mode. Accordingly, the hand phantom should have a posture specific to the data communication mode.

### BRIEF SUMMARY

One aspect provides for, on a user equipment that is proximate to a phantom, a method for determining the total radiated power of the user equipment includes in response to a preset criterion, obtaining a characteristic of the phantom, obtaining a characteristic of an antenna of the user equipment, and obtaining a radio characteristic of the user equipment. The method may also include transmitting the phantom characteristic, the antenna characteristic, and the radio characteristic to a test equipment.

In some embodiments of this aspect, the method further includes detecting a trigger measuring condition and carrying out the obtaining steps and the transmitting step in response to detecting the trigger measuring condition.

The trigger measuring condition may be the user equipment moving away from a serving cell and toward the test equipment.

The criterion may be a single event or a periodical event.

In some embodiments, the method further includes repeating the obtaining of the phantom characteristic, the obtaining of the antenna characteristic, and the obtaining of the radio characteristic for different configurations of the user equipment relative to the phantom.

The different configurations may be different positions of the user equipment relative to the phantom.

In some embodiments, the phantom is a head phantom, and the different configurations are different positions of the user equipment relative to the head phantom.

In some embodiments, the phantom is a hand phantom, and the different configurations comprises are different positions of the user equipment within the grip of the phantom.

In some embodiments, the different configurations are a data communication mode and a speech communication mode.

In some embodiments, the phantom is a head phantom and the characteristic is the cheek placement of the user equipment on the head phantom.

In some embodiments, the phantom is a hand phantom and the characteristic is the deflection of a finger on the hand phantom.

Another aspect is a method for determining the total radiated power of a user equipment is carried out on a test device. The method includes requesting a report from the user equipment. In response to the request, from the user equipment is received a report comprising a characteristic of a phantom that is proximate to the user equipment, a characteristic of an antenna of the user equipment, and a radio characteristic of the user equipment. The impact of the phantom characteristic, the antenna characteristic, and the radio characteristic on the radiated power of the user equipment is determined. The total radiated power in light of the phantom characteristics, antenna characteristics, and radio characteristics is calculated. An updated phantom characteristic, an updated radio characteristic, and an updated antenna characteristic is detected or obtained.

In some embodiments, the method for determining the total radiated power of a user equipment also includes repeating the determining, calculating and the detecting or obtaining steps until a test is complete.

In some embodiments of this method, the phantom is a head phantom and the characteristic is the cheek placement of the user equipment on the head phantom.

In some embodiments of this method, the phantom is a hand phantom and the characteristic is the deflection of a finger on the hand phantom.

In yet another aspect is provided a user equipment which includes an antenna, a memory, and a processor. In this embodiment, the processor retrieves instructions from the memory and executes the instructions to (in response to a preset criterion) obtain a characteristic of the phantom, obtaining a characteristic of an antenna of the user equipment, and obtaining a radio characteristic of the user equipment; and transmitting the phantom characteristic, the antenna characteristic, and the radio characteristic to a test equipment.

In some embodiments the processor also detects a trigger measuring condition carries out the obtaining steps and the transmitting step in response to detecting the trigger measuring condition.

In some embodiments, the trigger measuring condition is the user equipment moving away from a serving cell and toward the test equipment.

In some embodiments, the processor repeats the obtaining of the phantom characteristic, the obtaining of the antenna characteristic, and the obtaining of the radio characteristic for different configurations of the user equipment relative to the phantom.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a block diagram of a system according to an embodiment of the disclosure.

FIG. 2 is a block diagram of a UE or a test equipment according to an embodiment.

FIG. 3 is a diagram of a head phantom according to an embodiment.

FIG. 4 is a diagram of a hand phantom according to an embodiment.

FIG. 5 is a flowchart of a method for measuring signal strength according to an embodiment.

FIG. 6 is a flowchart of a method for obtaining phantom, radio and antenna characteristics information according to an embodiment.

FIG. 7 is a flowchart of a method for obtaining phantom, radio and antenna characteristics information according to another embodiment.

FIG. 8 is a diagram that illustrates an example of a trigger measuring condition according to an embodiment.

FIG. 9 is a diagram of a data transmission according to an embodiment.

FIG. 10 is a flowchart of a method for obtaining a phantom characteristic, a radio characteristic, and an antenna characteristic according to an embodiment.

FIG. 11 depicts an embodiment of a method for passive and active measurement of an over-the-air test system according to an embodiment.

### DETAILED DESCRIPTION

According to various embodiments, a method for measuring the total radiated power of wireless devices using the phantom characteristics, radio characteristics, and antenna characteristics in conjunction with a hand or head phantom is proposed.

A system is provided for measuring the total radiated power of wireless devices using the phantom characteristics, radio characteristics, and antenna characteristics in conjunction with a hand or head phantom is proposed. The system may include one or more of test equipment, a UCE and a phantom. The UE may be a multi-mode UE that is capable of communicating via multiple RATs. The multimode UE can include a processor configured to promote measurements of a signal strength in a communication system.

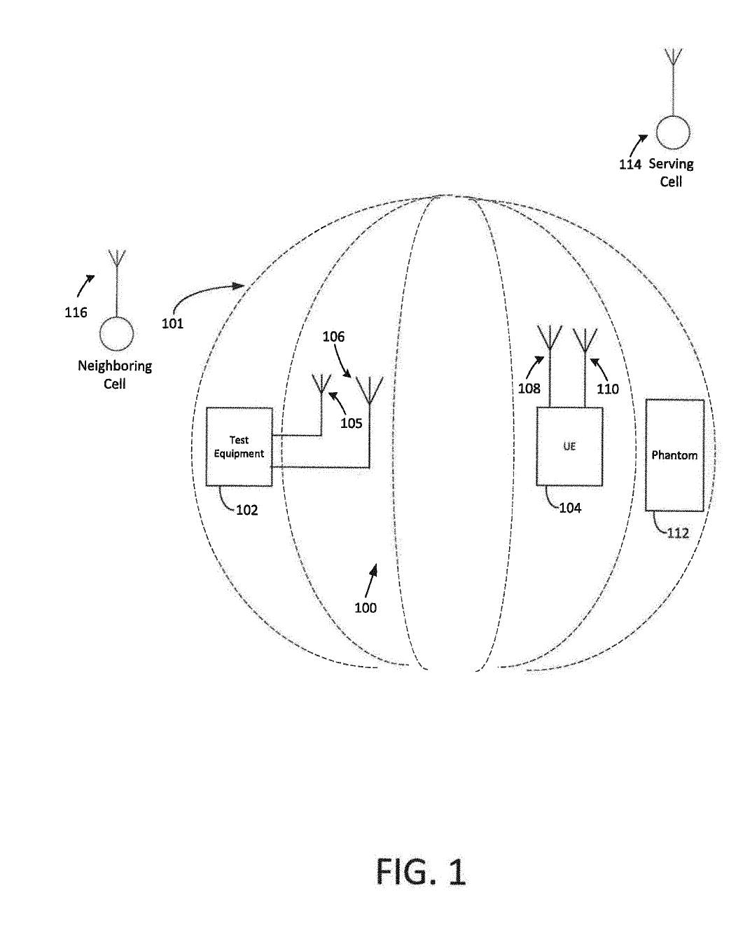

An exemplary embodiment of this system is shown in FIG. 1. In this embodiment, a system 100 that may be used to carry out various embodiments is generally labeled 100. The system 100 is located within a closed, spheroid chamber 101. The system 100 includes test equipment 102, a UE 104, and a phantom 112. In an embodiment, the UE 104 is a multi-mode UE that is capable of communicating via multiple RATs. Coupled to the test equipment 102 are one or more antennas (e.g., one for each RAT used by the test equipment 102), represented by antennas 105 and 106. The user equipment 104 includes one or more antenna (e.g., one for each RAT used by the user equipment 104), represented by antennas 108 and 110. The user equipment 104 is located proximate to the phantom 112. One or both of the test equipment 102 and the user equipment 104 may be in communication with a serving cell 114 and be within communication range of a neighboring cell 116.

According to another embodiment, radio waves emitted from a wireless device to be measured are reflected from an anechoic chamber or reverberation chamber and are then concentrated on the receiving antenna, with the total radiated power of the wireless device is measured. This embodiment is also illustrated in FIG. 1, where the chamber 101 is an anechoic chamber or a reverberation chamber. During a testing procedure, the UE 104 and the test equipment 102 are each placed at respective focal position of the chamber 101, with the UE 104 being placed proximate to the phantom 112. The UE 104 emits radio waves, which reflect off of inner walls of the chamber 101. Those reflected waves are concentrated on one or more of the antennas of the test equipment 102. The test equipment 102 then measures the TRP of the UE 104 in accordance with various methods described herein, taking into account one or more characteristics of the phantom 112, one or more characteristics of an antenna of the UE 104, and one or more radio characteristics of the UE 104. Having information regarding the phantom characteristics, radio characteristics, and antenna characteristics available allows the test equipment 102 to make more accurate calculations, which in turn may lead to improvement in measuring radiation power. By carrying out a test according to an embodiment, performance of the UE 104 can thereby be improved.

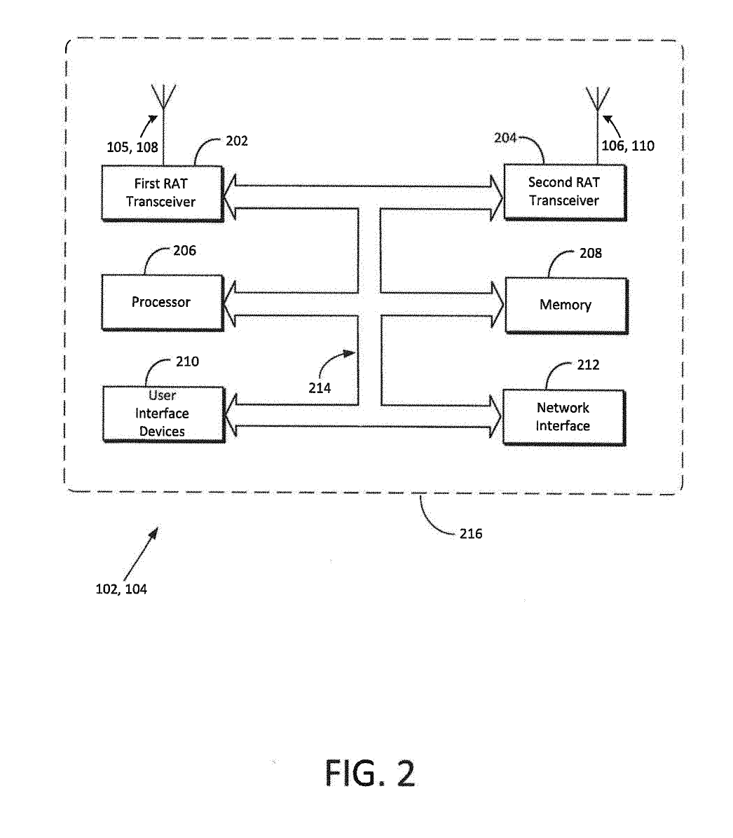

In various embodiments, one or more of the test equipment 102 and the user equipment 104 includes one or more of the components of FIG. 2. Turning to FIG. 2, the components include a first RAT transceiver 202, which is capable of sending and receiving data via a first RAT, and a second RAT transceiver 204, which is capable of sending and receiving data via a second RAT. The first RAT transceiver 202 and the second RAT transceiver 204 are each linked to respective antennas 105 and 106, or 108 and 110. The components of FIG. 2 further include a (hardware) processor 206, a memory 208, and user interface devices 210 (e.g., one or more of a touchscreen display and physical buttons), and a network interface 212. Each of these elements is communicatively linked to one another via one or more data pathways 214. Examples of data pathways include wires, conductive pathways on a microchip, and wireless connections. In one embodiment, all of the components of FIG. 2 are enclosed within a housing 216.

During operation of the test equipment 102 or the user equipment 104, one or more of the transceivers 202 and 204 receives data from the processor 206 and transmits radio-frequency signals representing the data via one or more of the antennas 105, 106, 108, and 110. Similarly, one or more of the transceivers 202 and 204 receives radio-frequency signals via one or more of the antennas 105, 106, 108, and 110, converts the signals into the appropriately formatted data, and provides the data to the processor 206. The processor 206 retrieves instructions from the memory 208 and, based on those instructions, provides outgoing data to one or more of the transceivers 202 and 204 or receives incoming data from the one or more of the transceivers 202 and 204. Similarly, based on the instructions, the processor 206 carries out one or more of the various methods disclosed herein, such as making the various measurements discussed herein, transmitting the various reports discussed herein in order to promote the measurement of a signal strength in a communication system.

The processor 206 may be any programmable device such as a computer, a microprocessor, a microcontroller, a set of peripheral integrated circuit elements, an integrated circuit (e.g., an application-specific integrated circuit), hardware/electronic logic circuits (e.g., a discrete element circuit), a programmable logic device (e.g., a programmable logic array), or a field programmable gate-array.

Possible implementations of the memory 208 include volatile memory, non-volatile memory, electrical, magnetic optical memory, random access memory (RAM), cache, and hard disc.

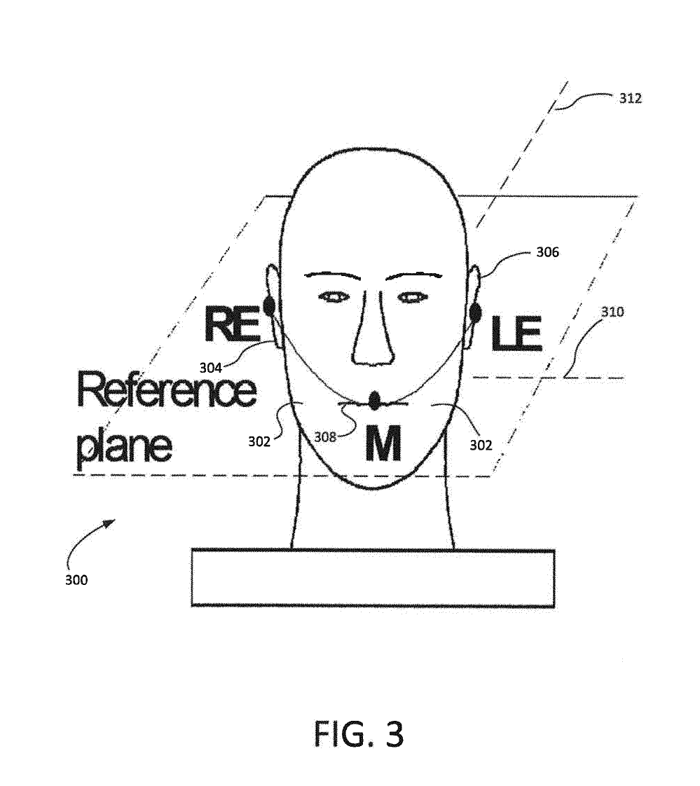

Turning to FIG. 3, an embodiment of the phantom 112 is shown. The phantom in this embodiment is a head phantom 300. The head phantom 300 includes a cheek part 302, a left ear part 304, a right ear part 306, and a mouth part 308. The head phantom 300 is located in an XY coordinate system which, in an embodiment, is known to both the test equipment 102 and the UE 104. The orientation of the UE 104 with respect to the left ear part 304, the right ear part 306, and the mouth part 308 is defined as a +X direction along an X-axis 310 and +Y direction along a Y-axis 312. In an embodiment, the UE 104 is coupled to the head phantom 300 in a speech communication mode.

Possible characteristics of the head phantom 300 include those set forth in Table 1.

TABLE 1
Head Phantom Characteristics

| ID | Cheek Placement | Characteristic Type |
|---|---|---|
| 0 | Low | Shift Down |
| 1 | Medium | No Shift |
| 2 | High | Shift Up |

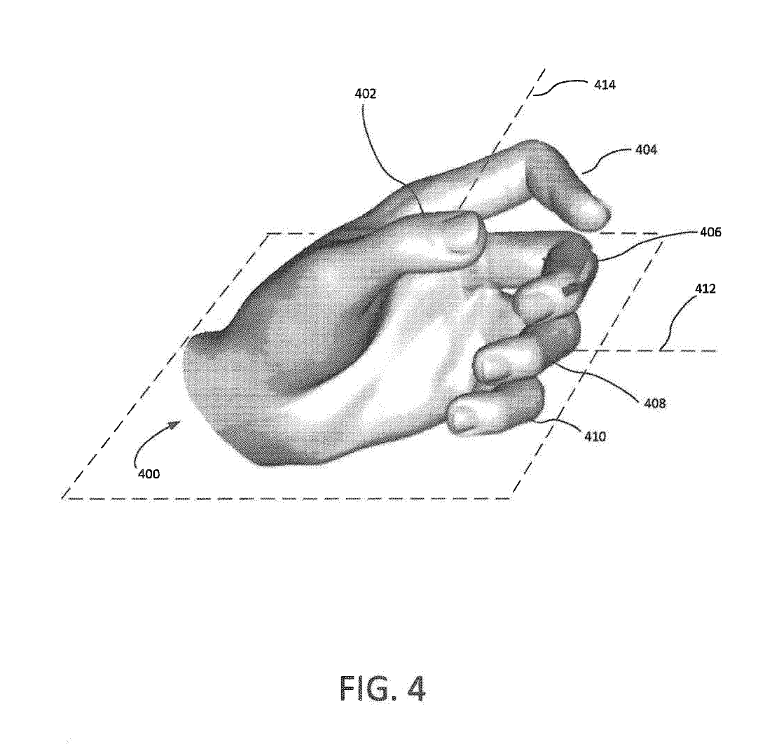

Turning to FIG. 4, another embodiment of the phantom 112 is shown. The phantom in this embodiment is a hand phantom 400. The hand phantom 400 includes a thumb part 402, an index finger part 404, a middle finger part 406, a ring finger part 408, and a pinky finger part 410, and in an XY coordinate system where for the wireless device being held, an orientation of the deflection of the index finger is defined as a +X direction along an X-axis 412 and +Y direction along a Y-axis 414 within the range of 2 and 5 mm. In an embodiment, an orientation of the hand grip is defined as a +X direction along the X-axis 412 and +Y direction along the Y-axis 414. The coordinate system is known to both the test equipment 102 and the UE 104 in an embodiment.

Possible characteristics of the hand phantom 400 (including finger characteristics) include those set forth in Table 2 and Table 3.

TABLE 2
Hand Phantom Characteristics

| ID | Hand Grip Placement | Characteristic Type |
|---|---|---|
| 0 | Low | Shift Up |
| 1 | Medium | No Shift |
| 2 | High | Shift Down |

TABLE 3
Hand Phantom Index Finger Characteristics

| | Deflection of Index | Characteristic |
|---|---|---|
| ID | Finger (df) Placement | Type |
| 0 | df ≥2 mm per 20 g | Rigid |
| 1 | 2 mm < df ≤ 5 mm per 20 g | Stable |
| 2 | df >5 mm per 20 g | Soft |

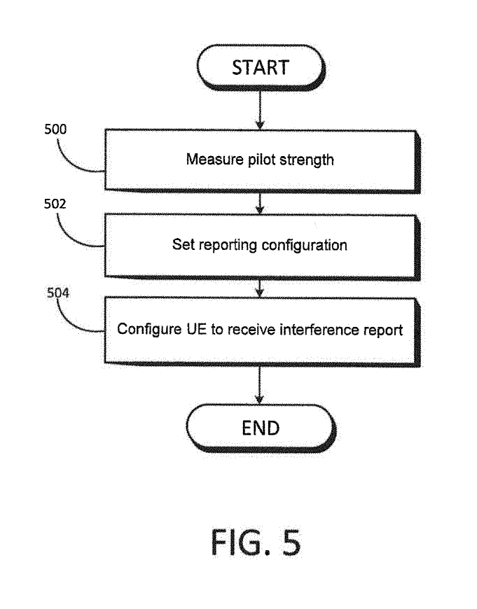

Turning to FIG. 5, a method that is carried out—e.g., by the UE 104—to measure signal strength in an embodiment will now be described. At block 500, a pilot strength is measured. For example, a UE may measure the strength of a pilot signal from an advanced technology network (e.g., an LTE network). At block 502, a reporting configuration for the UE is set. For example, the UE 104 is configured to report one or more characteristics of the phantom 112, a characteristic (or characteristics) of one or more of the antennas of the UE 104, and one or more radio characteristics being experienced by the UE 104. A criterion that triggers the UE to send the report may be a periodical event or a single event. At block 504, the UE is configured to receive an interference report. For example, the UE (such as the UE 104) is configured to receive a report to inform a serving cell (such as the serving cell 114) to inform the serving cell of the interference capability of the UE based on measurements received by the UE from the serving cell and a neighboring cell (such as the neighboring cell 116).

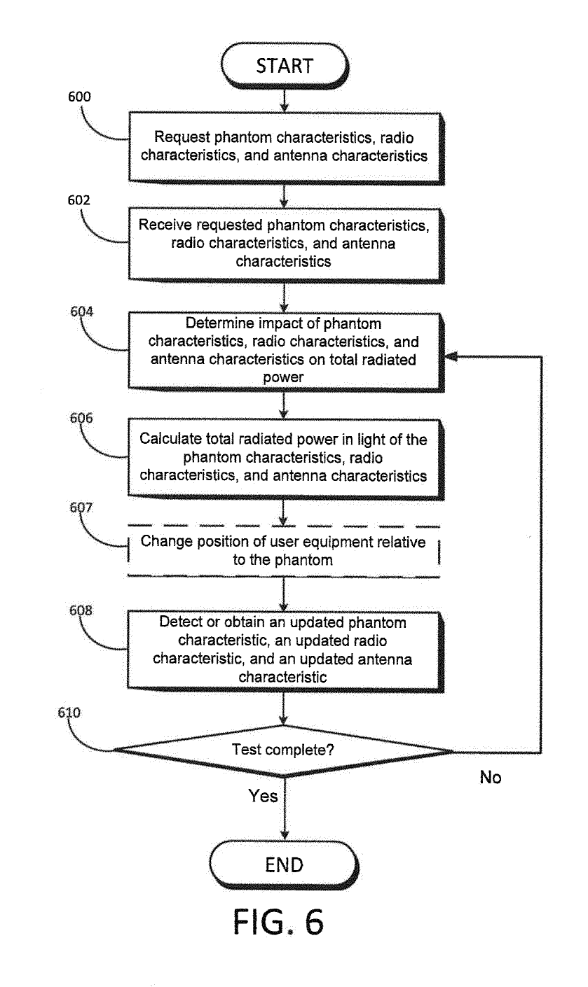

Turning to FIG. 6, a method that is carried out by the test equipment 102 to obtain phantom characteristics, radio characteristics, and antenna characteristics from the UE 104 according to an embodiment will now be described. At block 600, the test equipment 104 requests phantom characteristics, radio characteristics, and antenna characteristics from the UE 104. The UE 104 responds by determining one or more of the characteristics of the phantom 112, obtaining the radio characteristics of the UE 104, obtaining the antenna characteristics of one or more of the antennas of the UE 104, and transmitting these three pieces of information to the test equipment 102 (e.g., in a report in an OTA transmission). At block 602, the test equipment 102 receives the requested phantom characteristics, radio characteristics, and antenna characteristics (i.e., in the report). At block 604, the test equipment 102 determines the impact of the phantom characteristics, radio characteristics, and antenna characteristics on the TRP of the UE 104 (e.g., determines how to adjust its calculations of the TRP to account for those characteristics). At block 606, the test equipment 102 calculates the TRP of the UE 104 in light of the phantom characteristics, radio characteristics, and antenna characteristics. In some embodiments, at block 607, the position of the UE 104 relative to the phantom is changed. At block 608, the test equipment 608 detects or obtains updated phantom characteristics, radio characteristics, and antenna characteristics—e.g., from a subsequent report received from the UE 104 or from input by a user at the test equipment 102. At block 610, the test equipment 102 determines whether the test (e.g., the overall test of TRP for the UE 104) is complete. If yes, then the process ends. If no, then the process moves back to block 604.

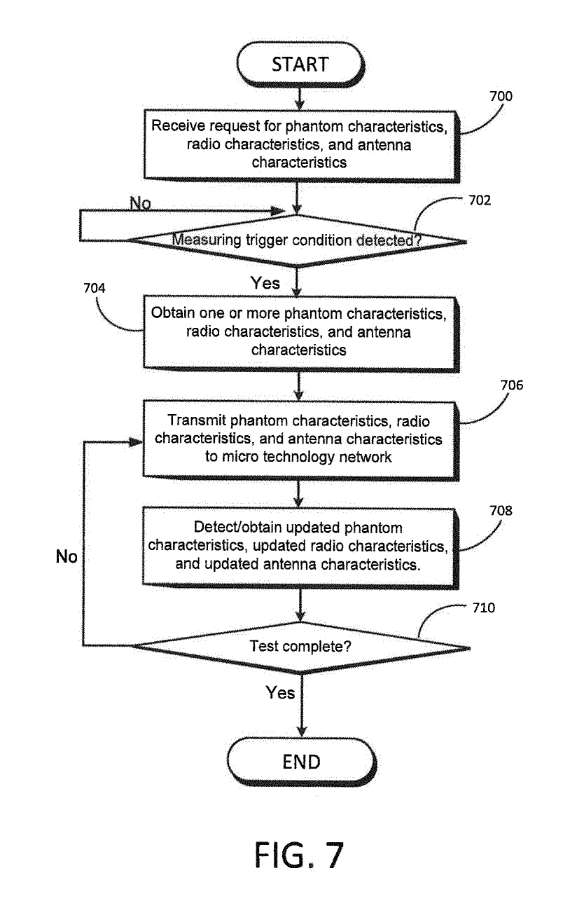

Turning to FIG. 7, a method that is carried out by the UE 104 to obtain phantom characteristics, radio characteristics, and antenna characteristics according to an embodiment will now be described. At block 700, the UE 104 receives a request—e.g., from the test equipment 102—for phantom characteristics, radio characteristics, and antenna characteristics. Otherwise, the UE 104 waits. At block 702, if the UE 104 detects a trigger measuring condition, it moves to block 704. At block 704, the UE 104 obtains one or more characteristics of the phantom 112, measures its own radio characteristics, and measures characteristics of one or more of the antennas of the UE 102. At block 706, the UE 104 transmits the phantom characteristics, the radio characteristics, and the antenna characteristics to the test equipment 102. In some embodiments, the configuration of the UE 104 is changed after block 706. For example, the configuration of the UE 104 is may be changed between a data communication mode and a speech communication mode. Or the position of the UE 104 may be changed relative to the phantom 112. At block 708, the UE 104 detects or obtains updated phantom characteristics, updated radio characteristics, and updated antenna characteristics. At block 710, if the test is complete, then the process ends. If the test is not complete, then the process continues returns to block 706.

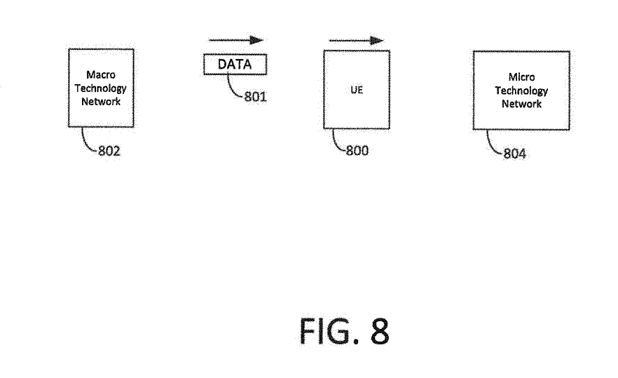

Turning to FIG. 8, an example of a trigger measuring condition (i.e., one that may occur when a measurement criterion has been fulfilled) will now be described. In this example, the measurement criterion is that a UE 800 (which could be the UE 104 of FIG. 1) is receiving data, in the form of a data transmission 801 from an eNB of a macro technology network 802 (which could be the serving cell 114) and is moving away from the macro technology network 802 but closer to a micro technology network 804 (which could be the test equipment 102). Thus, when the UE 800 determines that it is moving away from the macro technology network 802 but closer to the micro technology network 804, the UE 800 responds by (i.e., is triggered to) carry out the steps set forth in blocks 704 through 710 of FIG. 7.

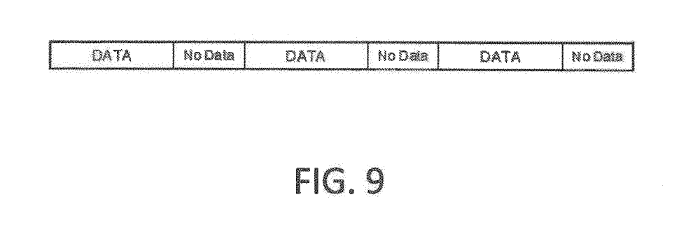

FIG. 9 illustrates a detailed view of a data transmission that a UE may send according to an embodiment. The data transmission includes a series data strings separated by transmission period in which no data is transmitted. The data strings might represent some type of a user-directed data transmission. During the period in which no data is transmitted, the UE can measure the strengths of the signals that it receives.

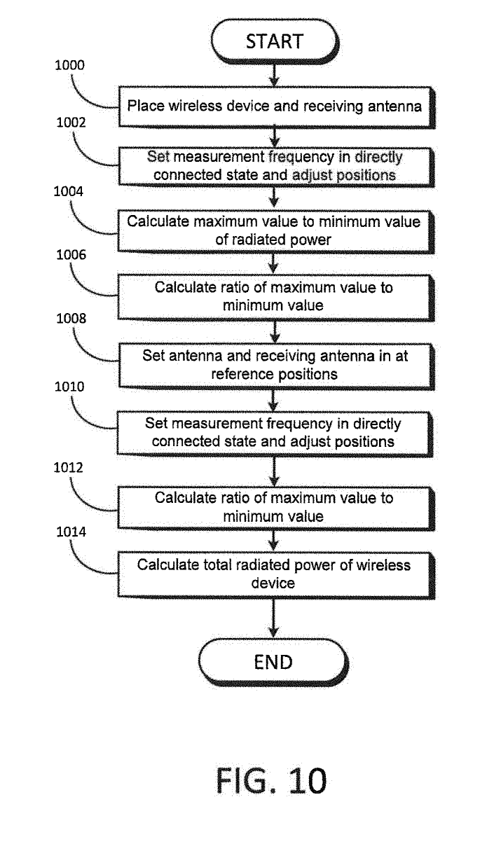

Turning to FIG. 10, a method for determining the radiated power of a wireless device according to an embodiment will now be described. At block 1000, the wireless device (e.g., the UE 104) and a receiving antenna (e.g., that of the test equipment 102) are placed (e.g., at focal positions of the chamber 101). At block 1002, the measurement frequency is set with the wireless device in a directly connected state (e.g., with the UE 104 and the test equipment 102 being directly connected), and the positions (e.g., of the UE 104 and the test equipment 102) are adjusted. At block 1004, the maximum value to the minimum value of the radiated power of the wireless device is calculated (e.g., by the test equipment 102). At block 1006, the ratio of the maximum value to the minimum value (calculated at block 1004) is calculated (e.g., by the test equipment 102). At block 1008, the transmitting antenna (e.g., one or more of the antennas of the UE 104 or the entire UE 104) and the receiving antenna (e.g., one or more of the antennas of the test equipment 102) are set (e.g., positioned at the focal points of the chamber 101). At block 1010, the measurement frequency is set with the wireless device in a directly connected state (e.g., with the UE 104 and the test equipment 102 being directly connected), and the positions (e.g., of the UE 104 and the test equipment 102) are adjusted. At block 1012, the maximum value to the minimum value of the radiated power of the wireless device is calculated (e.g., by the test equipment 102). At block 1014, the ratio of the maximum value to the minimum value (calculated at block 1004) is calculated (e.g., by the test equipment 102).

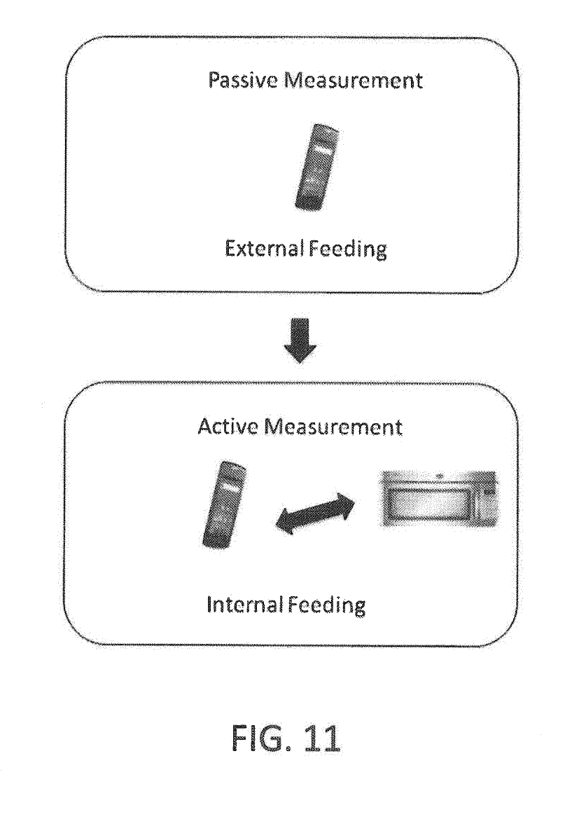

Finally, FIG. 11 depicts an embodiment of a method for passive and active measurement of an OTA test system.

According to various embodiments, the methods and devices described herein determine the radio resources and/or configuration parameters for testing a wireless device based on obtained phantom, radio, and antenna characteristics. Having the phantom, radio and antenna characteristics information available enables a system to make more accurate decisions, which in turn may lead to improvement in measuring radiation power.

In yet another aspect is provided a method to measure the total radiated power of wireless devices using the obtained phantom, radio and antenna characteristics and using a hand or head phantom, the following steps are carried out: 1) Perform a measurement; 2) Request phantom, radio and antenna characteristics; 3) Obtain phantom, radio and antenna characteristics; 4) Determine phantom, radio and antenna characteristics in relation to total radiated power, 5) Use phantom, radio and antenna characteristics in relation to total radiated power, 6) Detect/obtain updated phantom, radio and antenna characteristics; 7) Reporting configuration is set based on the criterion that triggers a multi-mode UE to send a measurement report; 8) The wireless device to be measured and a receiving antenna are arranged such as to focal positions of the closed space, which forms a spheroid; 9) Set wireless device to be measured and receiving antenna; 10) Set measurement frequency in directly connected state and adjust positions; 11) Calculate maximum value to minimum value; 12) Calculate ratio of maximum value to minimum value; 13) Set antenna and receiving antenna at reference positions; 14) Set measurement frequency in directly connected state and adjust positions; 15) Calculate ratio of maximum value to minimum value; 16) Calculate total radiation power of wireless device to be measured from.

In various embodiments of this aspect, the radio waves emitted from the wireless device to be measured are reflected from an anechoic chamber or reverberation chamber and are then concentrated on the receiving antenna, and the total radiated power of the wireless device to be measured is measured.

In various embodiments, the method includes creating a criterion that triggers a multi-mode UE to send a measurement report. This can either be periodical or a single event description.

In various embodiments, the above method includes a wireless device for obtaining phantom, radio and antenna characteristics for measuring total radiated power.

In various embodiments, the wireless device to be measured is arranged at the position as a complete coupling position based on the phantom, radio and antenna characteristics; the receiving antenna receives the radio waves emitted from the wireless device to be measured; the radiation power of the wireless device to be measured is calculated.

In various embodiments, the wireless device is held in the data communication mode.

While one or more embodiments of the have been described with reference to the figures, it will be understood by those of ordinary skill in the art that various changes in form and details may be made therein without departing from their spirit and scope of as defined by the following claims. For example, the steps of the flowcharts of FIGS. 5, 6, 7, and 10 can be reordered in way that will be apparent to those of skill in the art.

We claim:

1. On a user equipment that is proximate to a phantom, a method for determining the total radiated power of the user equipment, the method comprising:
in response to a preset criterion,
obtaining a characteristic of the phantom,
obtaining a characteristic of an antenna of the user equipment, and
obtaining a radio characteristic of the user equipment; and
transmitting the phantom characteristic, the antenna characteristic, and the radio characteristic to a test equipment.

2. The method claim 1, further comprising:
detecting a trigger measuring condition; and
carrying out the obtaining steps and the transmitting step in response to detecting the trigger measuring condition.

3. The method claim 2, wherein the trigger measuring condition is the user equipment moving away from a serving cell and toward the test equipment.

4. The method of claim 2, wherein the criterion is a single event.

5. The method of claim 2, wherein the criterion is a periodical event.

6. The method of claim 1, further comprising repeating the obtaining of the phantom characteristic, the obtaining of the antenna characteristic, and the obtaining of the radio characteristic for a plurality of different configurations of the user equipment relative to the phantom.

7. The method of claim 6, wherein the plurality of different configurations comprises a plurality of different positions of the user equipment relative to the phantom.

8. The method of claim 6, wherein the phantom is a head phantom, and the plurality of different configurations comprises a plurality of different positions of the user equipment relative to the head phantom.

9. The method of claim 6, wherein the phantom is a hand phantom, and the plurality of different configurations comprises a plurality of different positions of the user equipment within the grip of the phantom.

10. The method of claim 6, wherein the plurality of different configurations comprises a data communication mode and a speech communication mode.

11. The method of claim 1, wherein the phantom is a head phantom and the characteristic is the cheek placement of the user equipment on the head phantom.

12. The method of claim 1, wherein the phantom is a hand phantom and the characteristic is the deflection of a finger on the hand phantom.

13. On a test device, a method for determining the total radiated power of a user equipment, the method comprising:
requesting a report from the user equipment;
in response to the request, receiving, from the user equipment, a report comprising a characteristic of a phantom that is proximate to the user equipment, a characteristic of an antenna of the user equipment, and a radio characteristic of the user equipment;
determining the impact of the phantom characteristic, the antenna characteristic, and the radio characteristic on the radiated power of the user equipment;
calculating total radiated power in light of the phantom characteristics, antenna characteristics, and radio characteristics; and
detecting or obtaining an updated phantom characteristic, an updated radio characteristic, and an updated antenna characteristic.

14. The method of claim 13, further comprising repeating the determining, calculating and the detecting or obtaining steps until a test is complete.

15. The method of claim 13, wherein the phantom is a head phantom and the characteristic is the cheek placement of the user equipment on the head phantom.

16. The method of claim 13, wherein the phantom is a hand phantom and the characteristic is the deflection of a finger on the hand phantom.

17. A user equipment comprising:
an antenna;
a memory; and
a processor, wherein the processor retrieves instructions from the memory and executes the instructions to carry out steps comprising
in response to a preset criterion,
obtaining a characteristic of the phantom,
obtaining a characteristic of an antenna of the user equipment, and
obtaining a radio characteristic of the user equipment; and
transmitting the phantom characteristic, the antenna characteristic, and the radio characteristic to a test equipment.

18. The user equipment of claim 17, wherein the steps further comprise:
detecting a trigger measuring condition; and
carrying out the obtaining steps and the transmitting step in response to detecting the trigger measuring condition.

19. The user equipment of claim 17, wherein the trigger measuring condition is the user equipment moving away from a serving cell and toward the test equipment.

20. The user equipment of claim 17, wherein the steps further comprise repeating the obtaining of the phantom characteristic, the obtaining of the antenna characteristic, and the obtaining of the radio characteristic for a plurality of different configurations of the user equipment relative to the phantom.
